(19) United States
(12) Patent Application Publication
(10) Pub. No.: US 2010/0009735 A1
(43) Pub. Date: Jan. 14, 2010

(54) METHOD OF DISPLAY ADJUSTMENT FOR A VIDEO GAME SYSTEM

(75) Inventor: Henri Seydoux, Paris (FR)

Correspondence Address: HAVERSTOCK & OWENS LLP, 162 N WOLFE ROAD, SUNNYVALE, CA, 94086, US

(73) Assignee: PARROT, PARIS, FR (FR)

(21) Appl. No.: 12/446,621

(22) PCT Filed: Oct. 24, 2007
(86) PCT No.: PCT/FR07/01750

§ 371 Date: May 19, 2009

(30) Foreign Application Priority Data
Nov. 9, 2006 (FR) 0609776
Oct. 24, 2007 (FR) PCT/FR2007/001750

(51) Int. Cl. A63F 9/24; A63F 13/00

(52) U.S. Cl. 463/6; 463/31

(57) ABSTRACT

The invention relates to a method of display adjustment (49) for a video game system (1, 3). The system comprises a remotely-controlled vehicle (1) with a sensor (31) for sensing the attitude of the vehicle (1), and an electronic entity (3) including a display unit, the electronic entity (3) serving to control the vehicle (1) on a circuit, remotely. The method comprises the following steps: using the sensor (31) to acquire the instantaneous attitude of the vehicle (1) dynamically; dynamically estimating at least one inclination parameter of the circuit (57) from instantaneous attitude values delivered by the sensor (31); and adjusting the display (49) of the electronic entity as a function of the estimated values for the inclination parameter(s) of the circuit (57).

The invention relates to a method of display adjustment for a video game system.

Document US 2004/0110565 A1 describes a video game system having a central entity in communication with a head-up display and a position sensor. The system is used with a recreational vehicle, in particular a personal watercraft. The user is installed on the watercraft and moves therewith over a water surface while looking through the head-up display. The head-up display displays virtual elements that merge into the real view of the user traveling on the vehicle. The document envisages the head-up display encrusting virtual elements such as obstacles. The virtual obstacles are encrusted in the user's field of view as a function of the signal(s) delivered by one or more sensors, relating to the position or the speed of the vehicle.

However, the above-described document does not involve a remotely-controlled vehicle and does not provide any solution for adjusting the display of a video game system in the context of a remotely-controlled vehicle on a circuit.

Document FR 2 849 522 A1 describes a video game with remotely-controlled vehicles, but under no circumstances does it envisage a terrain that is not flat, where the problem would arise of matching real ups and downs with the image viewed by the player on a screen.

The object of the invention is thus to propose a method enabling such display adjustment to be performed in the context of a remotely-controlled vehicle traveling on a circuit.

According to the invention, this object is achieved by a method of display adjustment for a video game system, the system comprising:
a remotely-controlled vehicle with a sensor for sensing the attitude of the vehicle; and
an electronic entity including a display unit, the electronic entity serving to control the vehicle on a circuit remotely;

the method comprising the following steps:
using the sensor to acquire the instantaneous attitude of the vehicle dynamically;
dynamically estimating at least one inclination parameter of the circuit from instantaneous attitude values delivered by the sensor; and
adjusting the display of the electronic entity as a function of the estimated values for the inclination parameter(s) of the circuit.

The remotely-controlled vehicle may preferably be represented by a toy in the form of a land vehicle, in particular a race car. The electronic entity is preferably a portable unit, in particular a portable game console or a mobile telephone.

Advantageously, communication between the electronic entity and the remotely-controlled vehicle takes place by short-range radio transmission, in particular using Bluetooth or WiFi protocol (registered trademarks).

The term “attitude” of a vehicle is used to mean the position of the vehicle relative to a horizontal plane. In particular, it involves the angle made by the longitudinal axis of the vehicle relative to the horizontal. Attitude is thus the longitudinal inclination of the vehicle. This magnitude may also be referred to as pitching, i.e. the inclination about a transverse axis of the vehicle.

The display unit of the electronic entity is preferably a video screen, e.g. a liquid crystal display (LCD) screen, an active matrix screen, or some other video screen.

The vehicle attitude sensor may form part of an inertial unit on board the vehicle and used for sensing the position, the speed, and the heading of the vehicle.

The circuit on which the remotely-controlled vehicle travels is preferably a virtual circuit that is not defined in the real environment in which the vehicle is moving, but that is defined virtually by the video game system. In particular, the circuit may be a race track for a race game; under such circumstances, the remotely-controlled vehicle is a toy such as a race car.

The term “dynamic” is used in association with acquisition or estimation to mean that the acquisition and the estimation take place continuously in time. For example, dynamic acquisition may involve sampling the signal from the sensor at a certain frequency over time.

Preferably, dynamic estimation consists in taking a first average of the instantaneous attitude in the long term and/or a second average of the instantaneous attitude in the short term in order to estimate respectively a first parameter concerning the inclination of the circuit, i.e. its slope, and/or a second parameter concerning the inclination of the circuit, i.e. its roughness.

Preferably, the display of the electronic entity is constituted by a video image coming from a video sensors arranged on the remotely-controlled vehicle, with virtual elements being encrusted in the video image.

Furthermore, display adjustment may include adjusting virtual marks encrusted in the display of the electronic entity, the marks serving to define the circuit.

In addition, the method of the invention may include a training routine having the following steps:
storing estimated values for the inclination parameter(s) corresponding to a lap round the circuit; and
using the stored values to refine the estimation of the circuit inclination parameter(s).

The circuit inclination parameter(s) may be estimated by a Kalman filter, i.e. a filter having an infinite impulse response that estimates the states of a dynamic system from a series of measurements that are incomplete or noisy.

By means of the method of the invention, it is possible in particular to implement a race game with a remotely-controlled toy in the form of a race car. By dynamically acquiring the attitude of the vehicle during the game and dynamically estimating the inclination of the circuit that results therefrom, it is possible to provide a display on an electronic entity that emulates the circuit in satisfactory manner on the display.

When presenting the display on the electronic entity, it is thus possible to take account of the topography of the circuit, which topography is rarely flat or plane, and it is possible to this in real time.

There follows a description of implementations of methods of the invention, and of devices and systems representing ways in which the invention can be embodied, given with reference to the accompanying drawings in which the same numerical references are used from one figure to another to designate elements that are identical or functionally similar.

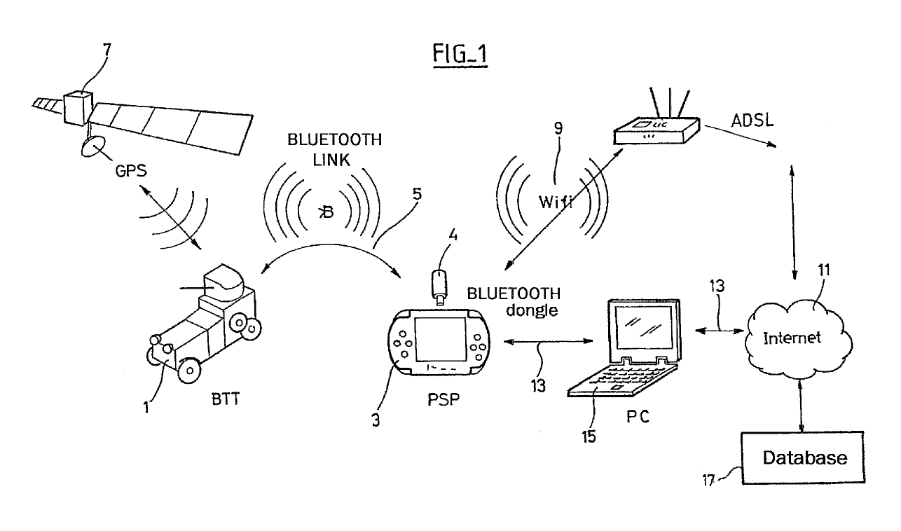

FIG. 1 is an overall view of the video game system of the invention;

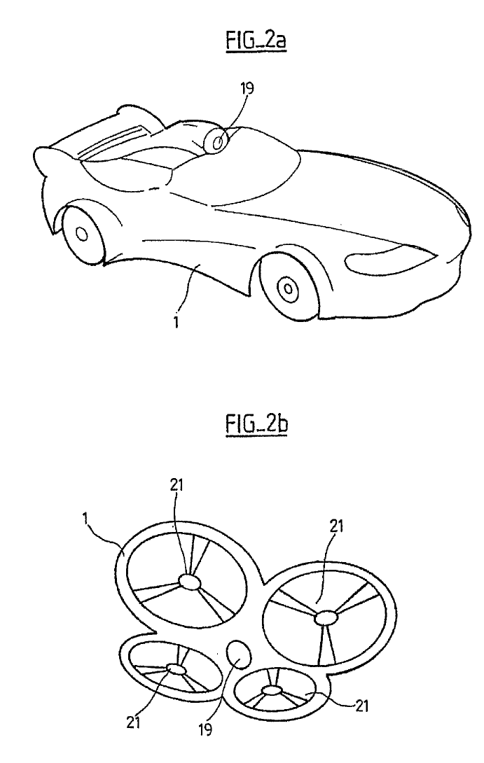

FIGS. 2a and 2b show two examples of remote-controlled vehicles of the invention;

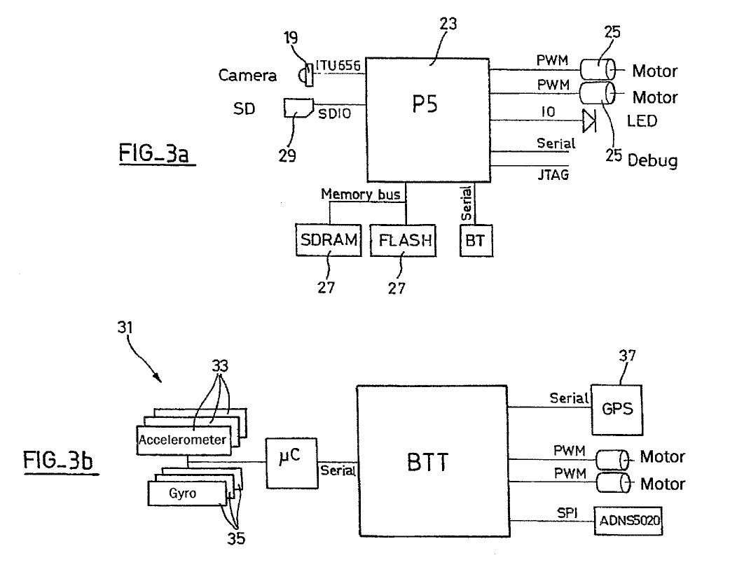

FIGS. 3a and 3b are block diagrams of the electronic elements of a remotely-controlled vehicle of the invention;

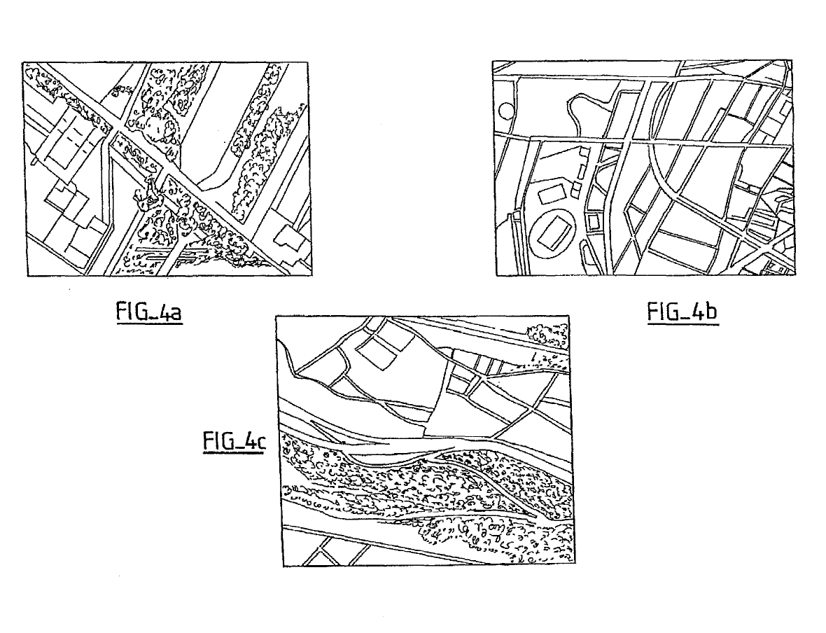

FIGS. 4a to 4c show various examples of aerial images in the video game system of the invention;

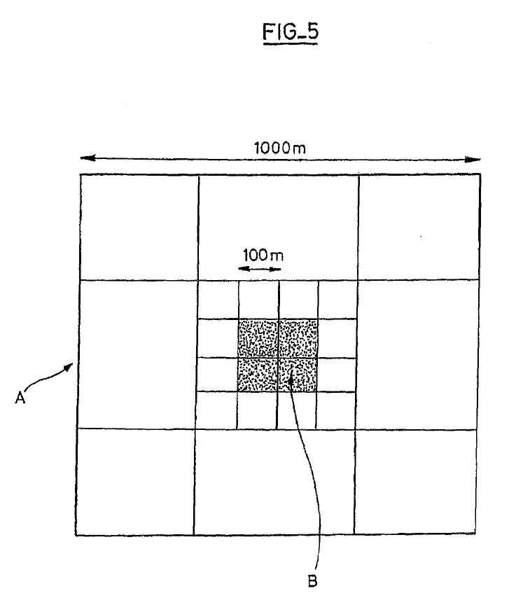

FIG. 5 shows a principle for defining game zones in the invention;

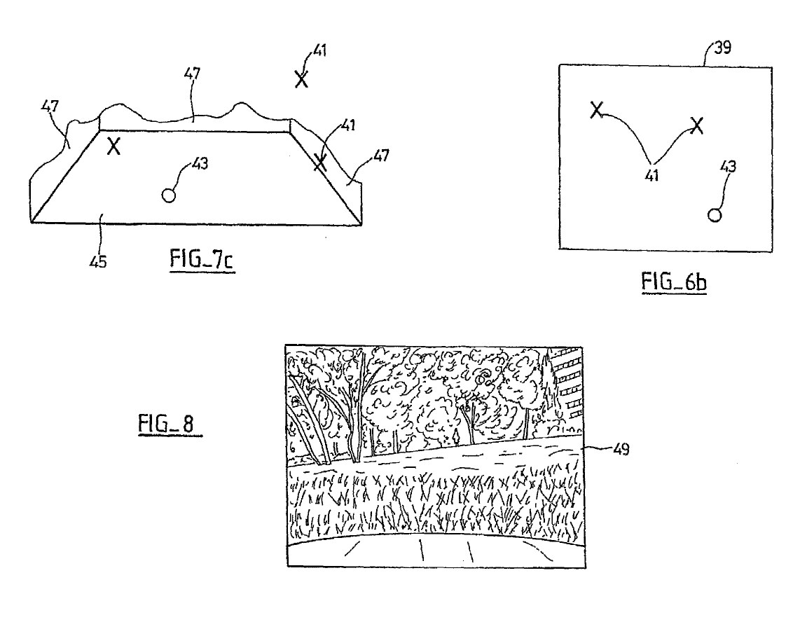

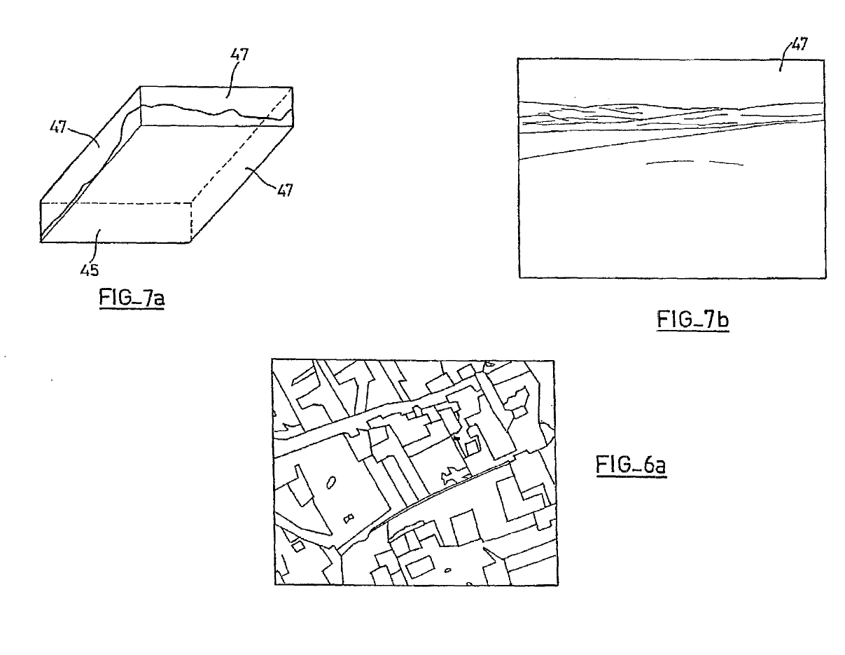

FIGS. 6a and 6b show the two-dimensional view of the invention;

FIGS. 7a to 7c show the perspective view of the invention;

FIG. 8 is an example of a view delivered by the video camera on board the remotely-controlled vehicle of the invention;

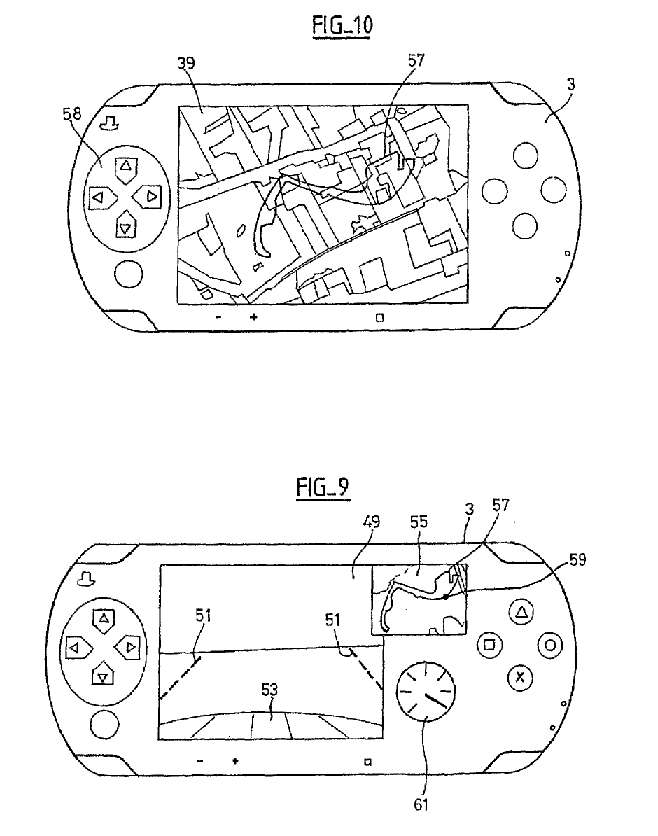

FIG. 9 shows an example of the display on the portable console of the invention;

FIG. 10 shows the virtual positioning of a race circuit on an aerial image of the invention;

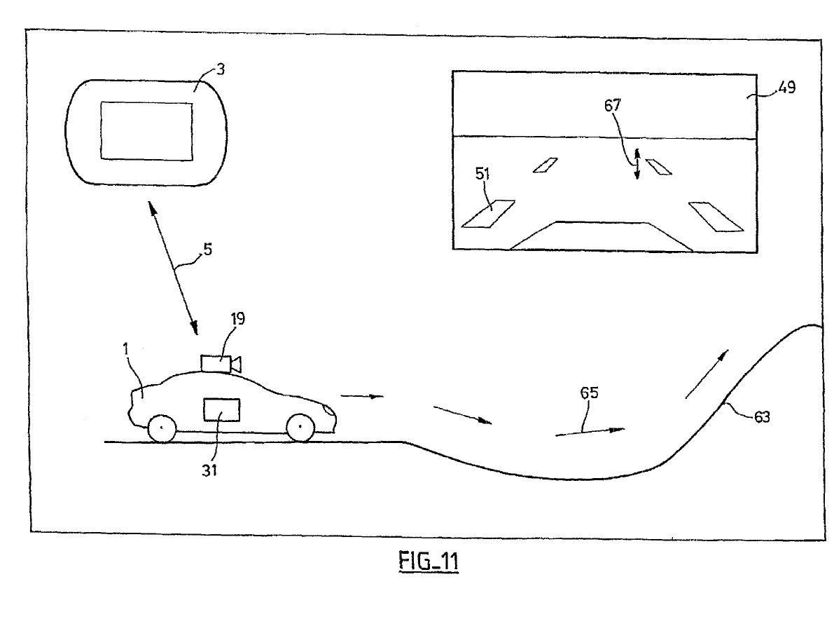

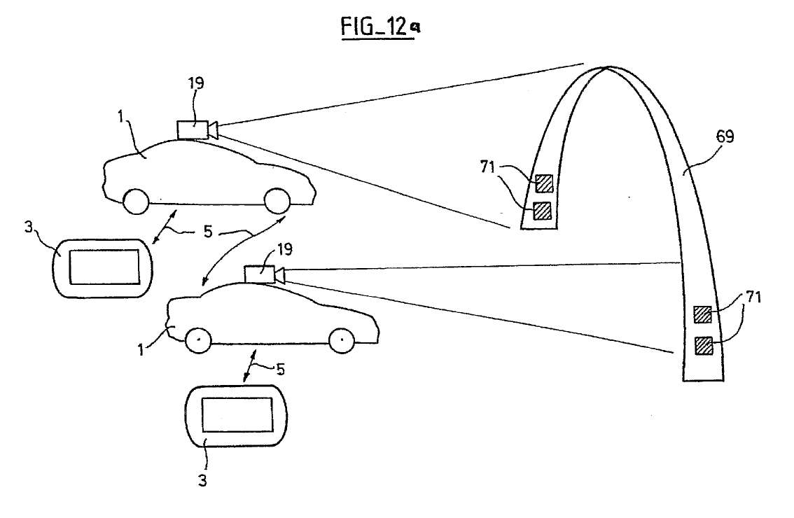

FIG. 11 shows the method of adjusting the display of the invention;

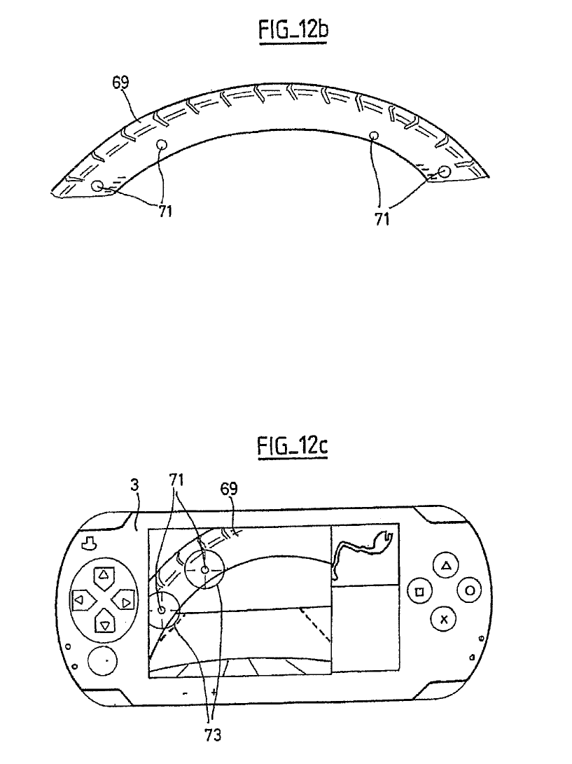

FIGS. 12a to 12c show a method of defining a common frame of reference of the invention; and

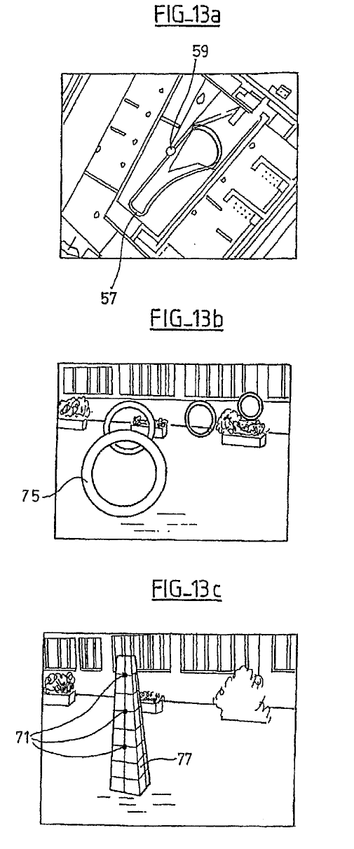

FIGS. 13a to 13c show an alternative version of a racing game of the invention.

FIG. 1 gives an overall view of a system of the invention.

The system comprises a video game system constituted by a remotely-controlled vehicle 1 (referred to by the acronym BTT for “BlueTooth Toy”, or WIT, for “WiFiToy”) together with a portable console 3 that communicates with the vehicle 1 via a Bluetooth link 5. The vehicle 1 may be remotely-controlled by the portable console 3 via the Bluetooth link 5.

The vehicle 1 is in communication with a plurality of satellites 7 via a GPS sensor on board the vehicle 1.

The portable console 3 may be fitted with a broadband wireless connection giving access to the Internet, such as a WiFi connection 9.

This connection enables the console 3 to access the Internet 11.

Alternatively, if the portable console is not itself fitted with an Internet connection, it is possible to envisage an indirect connection to the Internet 13 via a computer 15.

A database 17 containing aerial images of the Earth is accessible via the Internet 11.

By way of example, FIGS. 2a and 2b show two different embodiments of the remotely-controlled vehicle 1. In FIG. 2a, the remotely-controlled vehicle 1 is a race car. This race car 1 has a video camera 19 incorporated in its roof. The image delivered by the video camera 19 is communicated to the portable console 3 via the Bluetooth link 5 in order to be displayed on the screen of the portable console 3.

FIG. 2b shows that the remotely-controlled toy 1 may also be constituted by a four-propeller “quadricopter” 21. As for the race car, the quadricopter 1 has a video camera 19 in the form of a dome located at the center thereof.

Naturally, the remotely-controlled vehicle 1 may also be in the form of some other vehicle, e.g. in the form of a boat, a motorcycle, or a tank.

To summarize, the remotely-controlled vehicle 1 is essentially a piloted vehicle that transmits video, and that has sensors associated therewith.

FIGS. 3a and 3b are diagrams showing the main electronic components of the remotely-controlled vehicle 1.

FIG. 3a shows in detail the basic electronic components. A computer 23 is connected to various peripheral elements such as a video camera 19, motors 25 for moving the remotely-controlled vehicle, and various memories 27 and 29. The memory 29 is an SD card, i.e. a removable memory card for storing digital data. The card 29 may be omitted, but it is preferably retained since it serves to record the video image delivered by the camera 19 so as to make it possible to look back through recorded video sequences.

FIG. 3b shows the additional functions on board the remotely-controlled vehicle 1. The vehicle 1 essentially comprises two additional functions: an inertial unit 31 having three accelerometers 33 and three gyros 35, and a GPS sensor 37.

The additional functions are connected to the computer 23, e.g. via a serial link. It is also possible to add a USB (universal serial bus) connection to the vehicle 1 in order to be able to update the software executed in the electronic system of the vehicle 1.

The inertial unit 31 is an important element of the vehicle 1. It serves to estimate accurately and in real time the coordinates of the vehicle. In all, it estimates nine coordinates for the vehicle: the positions X, Y, and Z of the vehicle in three-dimensional space; the angles of orientation θ, ψ, φ of the vehicle (Eulerian angles); and the speeds VX, VY, and VZ along each of the three Cartesian axes X, Y, and Z.

These movement coordinates come from the three accelerometers 33 and from the three gyros 35. These coordinates may be obtained from a Kalman filter receiving the outputs from the measurements provided by the sensors.

More precisely, the microcontroller takes the measurement and forwards it via the serial link or serial bus (serial peripheral interconnect, SPI) to the computer 23. The computer 23 mainly performs Kalman filtering and delivers the position of the vehicle 1 as determined in this way to the game console 3 via the Bluetooth connection 5. The filtering calculation may be optimized: the computer 23 knows the instructions that are delivered to the propulsion and steering motors 25. It can use this information to establish the prediction of the Kalman filter. The instantaneous position of the vehicle 1 as determined with the help of the inertial unit 31 is delivered to the game console 3 at a frequency of 25 hertz (Hz), i.e. the console receives one position per image.

If the computer 23 is overloaded in computation, the raw measurements from the inertial unit 31 may be sent to the game console 3, which can itself perform the Kalman filtering instead of the computer 23. This solution is not desirable in terms of system simplicity and coherence, since it is better for all of the video game computation to be performed by the console and for all of the data acquisition to be performed by the vehicle 1, but nevertheless it can be envisaged.

The sensors of the inertial unit 31 may be implemented in the form of piezoelectric sensors. These sensors vary considerably with temperature, which means that they need to be maintained at a constant temperature with a temperature probe and a rheostat, and that by using a temperature probe, it is necessary to measure the temperature level of the piezoelectric sensors and to compensate in software for the variations of the sensors with temperature.

The GPS sensor 37 is not an essential function of the remotely-controlled vehicle 1. Nevertheless, it provides great richness in terms of functions at modest cost. A down-market GPS suffices, operating mainly outdoors and without any need for real time tracking of the path followed, since the real time tracking of the path is performed by the inertial unit 29. It is also possible to envisage using GPS in the form of software.

The game console 3 is any portable console that is available on the market. Presently-known examples of portable consoles are the Sony portable Playstation (PSP) or the Nintendo Nintendo DS. It may be provided with a Bluetooth key (dongle) 4 (cf. FIG. 1) for communicating by radio with the vehicle 1.

The database 17 (FIG. 1) contains a library of aerial images, preferably of the entire Earth. These photos may be obtained from satellites or airplanes or helicopters. FIGS. 4a to 4c show various examples of aerial images that can be obtained from the database 17. The database 17 is accessible via the Internet so that the console 3 can have access thereto.

The aerial images downloaded from the database 17 are used by the game console 3 to create synthesized views that are incorporated in the video games that are played on the console 3.

There follows a description of the method whereby the console 3 acquires aerial images from the database 17. For this purpose, the user of the console 3 places the remotely-controlled vehicle 1 at a real location, such as in a park or a garden, where the user seeks to play. By means of the GPS sensor 37, the vehicle 1 determines its terrestrial coordinates. These are then transmitted via the Bluetooth or WiFi link 5 to the console 3. The console 3 then connects via the WiFi link 9 and the Internet to the database 17. If there is no WiFi connection at the site of play, the console 3 stores the determined terrestrial position. Thereafter the player goes to a computer 15 having access to the Internet. The player connects the console 3 to the computer and the connection between the console 3 and the database 17 then takes place indirectly via the computer 15. Once the connection between the console 3 and the database 17 has been set up, the terrestrial coordinates stored in the console 3 are used to search for aerial images or maps in the database 17 that correspond to the terrestrial coordinates. Once an image has been found in the database 17 that reproduces the terrestrial zone in which the vehicle 1 is located, the console 3 downloads the aerial image that has been found.

FIG. 5 gives an example of the geometrical definition of a two-dimensional games background used for a video game involving the console 3 and the vehicle 1.

The squares and rectangles shown in FIG. 5 represent aerial images downloaded from the database 17. The overall square A is subdivided into nine intermediate rectangles. These nine intermediate rectangles include a central rectangle that is itself subdivided into 16 squares. Of these 16 squares, the four squares at the center represent the game zone B proper. This game zone B may be loaded at the maximum definition of the aerial images, and the immediate surroundings of the game zone B, i.e. the 12 remaining squares out of the 16 squares, may be loaded with aerial images at lower definition, and the margins of the game as represented by the eight rectangles that are not subdivided, and that are located at the periphery of the subdivided central rectangle, may be loaded with aerial images from the database at even lower definition. By acting on the definition of the various images close to or far away from the center of the game, the quantity of data that needs to be stored and processed by the console can be optimized while the visual effect and putting into perspective do not suffer. The images furthest from the center of the game are displayed with definition that corresponds to their remoteness.

The downloaded aerial images are used by the console 3 to create different views that can be used in corresponding video games. More precisely, it is envisaged that the console 3 is capable of creating at least two different views from the downloaded aerial images, namely a vertical view in two dimensions (cf. FIGS. 6a and 6b) and a perspective view in three dimensions (cf. FIGS. 7a to 7c).

FIG. 6a shows an aerial image as downloaded by the console 3. The remotely-controlled vehicle 1 is located somewhere on the terrain viewed by the aerial image of FIG. 6a. This aerial image is used to create a synthesized image as shown diagrammatically in FIG. 6b. The rectangle 39 represents the aerial image of FIG. 6a. The rectangle 39 has encrusted therein three graphics objects 41 and 43. These graphics objects represent respectively the position of the remotely-controlled vehicle on the game zone represented by the rectangle 39 (cf. spot 43 that corresponds to the position of the remotely-controlled vehicle), and the positions of other real or virtual objects (cf. the crosses 41 that may, for example, represent the positions of real competitors or virtual enemies in a video game).

It is possible to envisage the software of the vehicle 1 taking care to ensure that the vehicle does not leave the game zone as defined by the rectangle 39.

FIGS. 7a and 7c show the perspective view that can be delivered by the console 3 on the basis of the downloaded aerial images. This perspective image comprises a “ground” 45 with the downloaded aerial image inserted therein. The sides 47 are virtual images in perspective at infinity, with an example thereof being shown in FIG. 7b. These images are generated in real time by the three-dimensional graphics engine of the game console 3.

As in the two-dimensional view, graphics objects 41 and 43 indicate to the player the position of the player's own vehicle (43) and the position of other players or potential enemies (41).

In order to create views, it is also possible to envisage downloading an elevation mesh from the database 17.

FIG. 8 shows the third view 49 that is envisaged in the video game system, namely the view delivered by the video camera 19 on board the remotely-controlled vehicle 1. FIG. 8 shows an example of such a view. In this real video image, various virtual graphics objects are encrusted as a function the video game being played by the player.

FIG. 9 shows the game console 3 with a display that summarizes the way in which the above-described views are presented to the player. There can clearly be seen the view 49 corresponding to the video image delivered by the video camera 19. The view 49 includes virtual encrustations 51 that, in FIG. 9, are virtual markers that define the sides of a virtual circuit. In the view 49, it is also possible to see the real hood 53 of the remotely-guided vehicle 1.

The second view 55 corresponds to the two-dimensional vertical view shown in FIGS. 6a and 6b. The view 55 is made up of the reproduction of an aerial image of the game terrain, having encrusted thereon a virtual race circuit 57 with a point 59 moving around the virtual circuit 57. The point 59 indicates the actual position of the remotely-guided vehicle 1. As a function of the video game, the two-dimensional view 55 may be replaced by a perspective view of the kind described above. Finally, the display as shown in FIG. 9 includes a third zone 61, here representing a virtual fuel gauge for the vehicle 1.

There follows a description of an example of a video game for the video game system shown in FIG. 1. The example is a car race performed on a real terrain with the help of the remotely-controlled vehicle 1 and the game console 3, with the special feature of this game being that the race circuit is not physically marked out on the real terrain but is merely positioned in virtual manner on the real game terrain on which the vehicle 1 travels.

In order to initialize the video race game, the user proceeds by acquiring the aerial image that corresponds to the game terrain in the manner described above. Once the game console 3 has downloaded the aerial image 39 reproducing a vertical view of the game terrain on which the vehicle 1 is located, the software draws a virtual race circuit 57 on the downloaded aerial image 39, as shown in FIG. 10. The circuit 57 is generated in such a manner that the virtual start line is positioned on the aerial image 39 close to the geographical position of the vehicle 1. This geographical position of the vehicle 1 corresponds to the coordinates delivered by the GPS module, having known physical values concerning the dimensions of the vehicle 1 added thereto.

Using the keys 58 on the console 3, the player can cause the circuit 57 to turn about the start line, can subject the circuit 57 to scaling while keeping the start line as the invariant point of the scaling (with scaling being performed in defined proportions that correspond to the maneuverability of the car), or can cause the circuit to slide around the start line.

It is also possible to make provision for the start line to be moved along the circuit, in which case the vehicle needs to move to the new start line in order to start a game.

This can be of use, for example when the garden where the player seeks to play the video game is not large enough to contain the circuit as initially drawn by the software. The player can thus change the position of the virtual circuit until it is indeed positioned on the real game terrain.

With a flying video toy that constitutes one of the preferred applications, e.g. a quadricopter, an inertial unit of the flying vehicle is used to stabilize it. A flight instruction is transmitted by the game console to the flying vehicle, e.g. “hover”, “turn right”, or “land”. The software of the microcontroller on board the flying vehicle makes use of its flight controls: modifying the speed of the propellers or controlling aerodynamic flight surfaces so as to make the measurements taken by the inertial unit coincide with the flight instruction.

Likewise, with a video toy of the motor vehicle type, instructions are relayed by the console to the microcontroller of the vehicle, e.g. “turn right” or “brake” or “speed 1 meter per second (m/s)”.

The video toy may have main sensors, e.g. a GPS and/or an inertial unit made up of accelerometers or gyros. It may also have additional sensors such as video camera, means for counting the revolutions of the wheels of a car, an air pressure sensor for estimating speed of a helicopter or an airplane, a water pressure sensor for determining depth in a submarine, or analog-to-digital converters for measuring electricity consumption at various points of the on-board electronics, e.g. the consumption of each electric motor for propulsion or steering.

These measurements can be used for estimating the position of the video toy on the circuit throughout the game sequence.

The measurement that is most used is that from the inertial unit that comprises accelerometers and/or gyros. This measurement can be checked by using a filter, e.g. a Kalman filter, serving to reduce noise and to combine measurements from other sensors, cameras, pressure sensors, motor electricity consumption measurements, etc.

For example, the estimated position of the vehicle 1 can be periodically recalculated by using the video image delivered by the camera 19 and by estimating movement on the basis of significant fixed points in the image scene, which are preferably high contrast points in the video image. The distance to the fixed points may be estimated by minimizing matrices using known triangulation techniques.

Position may also be recalculated over a longer distance (about 50 meters) by using GPS, in particular recent GPS modules that measure the phases of the signals from the satellites.

The speed of the video toy may be estimated by counting wheel revolutions, e.g. by using a coded wheel.

If the video toy is propelled by an electric motor, its speed can also be estimated by measuring the electricity consumption of said motor. This requires knowledge of the efficiency of the motor at different speeds, as can be measured beforehand on a test bench.

Another way of estimating speed is to use the video camera 19. For a car or a flying vehicle, the video camera 19 is stationary relative to the body of the vehicle (or at least its position is known), and its focal length is also known. The microcontroller of the video toy performs video coding of MPEG4 type, e.g. using H263 or H264 coding. Such coding involves calculation predicting the movement of a subset of the image between two video images. For example the subset may be a square of 16*16 pixels. Movement prediction is preferably performed by a physical accelerometer. The set of movements of the image subset provides an excellent measurement of the speed of the vehicle. When the vehicle is stationary, the sum of the movements of the subsets of the image is close to zero. When the vehicle is advancing in a straight line, the subsets of the image move away from the vanishing point with a speed that is proportional to the speed of the vehicle.

In the context of the race car video game, the screen is subdivided into a plurality of elements, as shown in FIG. 9. The left element 49 displays the image delivered by the video camera 19 of the car 1. The right element 55 shows the map of the race circuit together with competing cars (cf. the top right view in FIG. 9).

Indicators may display real speed (at the scale of the car). Game parameters may be added, such as the speed or the fuel consumption of the car, or they may be simulated (as for a Formula 1 grand prix race).

In the context of this video game, the console can also store races. If only one car is available, it is possible to race against oneself. Under such circumstances, it is possible to envisage displaying transparently on the screen a three-dimensional image showing the position of the car during a stored lap.

FIG. 11 shows in detail how virtual encrustations 51, i.e. race circuit markers, are adapted in the display 49 corresponding to the view from the corresponding video camera on board the vehicle 1. FIG. 11 is a side view showing the topography 63 of the real terrain on which the vehicle 1 is moving while playing the race video game. It can be seen that the ground of the game terrain is not flat, but presents ups and downs. The slope of the terrain varies, as represented by arrows 65.

Consequently, the encrustation of the circuit markers 51 in the video image cannot be static but needs to adapt as a function of the slope of the game terrain. To take this problem into account, the inertial unit 31 of the vehicle 1 has a sensor for sensing the attitude of the vehicle. The inertial sensor performs real time acquisition of the instantaneous attitude of the vehicle 1. From instantaneous attitude values, the electronics of the vehicle 1 estimate two values, namely the slope of the terrain (i.e. the long-term average of the attitude) and the roughness of the circuit (i.e. the short-term average of the attitude). The software uses the slope value to compensate the display, i.e. to move the encrusted markers 51 on the video image, as represented by arrow 67 in FIG. 11.

Provision is also made to train the software that adjusts the display of the markers 51. After the vehicle 1 has traveled a first lap round the virtual circuit 57, the values for slope and roughness all around the circuit are known, stored, and used in the prediction component of a Kalman filter that re-estimates slope and roughness on the next lap.

The encrustation of the virtual markers 51 on the video image can thus be improved by displaying only discontinuous markers and by displaying a small number of markers, e.g. only four markers on either side of the road. Furthermore, the distant markers may be of a different color and may serve merely as indications and not as real definitions of the outline of the track. In addition, the distant markers may also be placed further apart than the near markers.

Depending on the intended application, it may also be necessary to estimate the roll movement of the car in order to adjust the positions of the markers 51, i.e. to estimate any possible tilt of the car about its longitudinal axis.

The circuit roughness estimate is preferably used to extract the slope measurement from the data coming from the sensor.

In order to define accurately the shape of the ground on which the circuit is laid, a training stage may be performed by the video game. This training stage is advantageously performed before the game proper, at a slow and constant speed that is under the control of the game console. The player is asked to take a first lap around the circuit during which the measurements from the sensors are stored. At the end of the lap round the track, the elevation values of numerous points of the circuit are extracted from the stored data. These elevation values are subsequently used during the game to position the virtual markers 51 properly on the video image.

FIGS. 12a to 12c show a method of defining a common frame of reference when the race game is performed by two or more remotely-controlled vehicles 1. In this context, there are two players each having a remotely-controlled vehicle 1 and a portable console 3. These two players seek to race two cars against each other around the virtual race circuit 57 using their two vehicles 1. The initialization of such a two-player game may be performed, for example, by selecting a “two-car” mode on the consoles. This has the effect of the Bluetooth or WiFi protocol in each car 1 entering a “partner search” mode. Once the partner car has been found, each car 1 informs its own console 3 that the partner has been found. One of the consoles 1 is used for selecting the parameters of the game: selecting the race circuit in the manner described above, the number of laps for the race, etc. Then a countdown is started on both consoles: the two cars communicate with each other using the Bluetooth or WiFi protocol. In order to simplify exchanges between the various peripherals, each car 1 communicates with its own console 3 but not with the consoles of the other cars. The cars 1 then send their coordinates in real time and each car 1 sends its own coordinates and the coordinates of the competitor(s) to the console 3 from which it is being driven. On the console, the display of the circuit 55 shows the positions of the cars 1.

In such a car game, the Bluetooth protocol is in a “Scatternet” mode. One of the cars is then a “Master” and the console with which it is paired is a ‘Slave’, and the other car is also a “Slave”. In addition, the cars exchange their positions with each other. Such a race game with two or more remotely-controlled vehicles 1 requires the cars 1 to establish a common frame of reference during initialization of the game. FIGS. 12a to 12c show details of defining a corresponding common frame of reference.

As shown in FIG. 12a, the remotely-controlled vehicles 1 with their video cameras 19 are positioned facing a bridge 69 placed on the real game terrain. This real bridge 69 represents the starting line and it has four light-emitting diodes (LEDs) 71. Each player places the corresponding car 1 in such a manner that at least two of the LEDs 71 are visible on the screen of the player's console 3.

The LEDs 71 are of known colors and they may flash at known frequencies. In this way, the LEDs 71 can easily be identified in the video images delivered respectively by the two video cameras 19. A computer present on each of the vehicles 1 or in each of the consoles 3 processes the image and uses triangulation to estimate the position of the corresponding car 1 relative to the bridge 69.

Once a car 1 has estimated its position relative to the bridge 69, it transmits its position to the other car 1. When both cars 1 have estimated their respective positions relative to the bridge 69, the positions of the cars 1 relative to each other are deduced therefrom and the race can begin.

FIG. 12b is a view of the front of the bridge 69 showing the four LEDs 71. FIG. 12c shows the display on the console 3 during the procedure of determining the position of a vehicle 1 relative to the bridge 69. In FIG. 12c, it can clearly be seen that the computer performing image processing has managed to detect the two flashing LEDs 71, as indicated in FIG. 12c by two cross-hairs 73.

Defining a common frame of reference relative to the ground and between the vehicles is particularly useful for a race game (each vehicle needs to be referenced relative to the race circuit).

For some other video games, such as a shooting game, defining a common frame of reference is simpler: for each vehicle, it suffices to know its position relative to its competitors.

FIGS. 13a to 13c are photos corresponding to an alternative version of the race video game, the race game now involving not one or more cars 1, but rather one or more quadricopters 1 of the kind shown in FIG. 2b. Under such circumstances, where the remotely-controlled vehicle 1 is a quadricopter, the inertial unit is not only used for transmitting the three-dimensional coordinates of the toy to the console 3, but also for providing the processor on board the quadricopter 1 with the information needed by the program that stabilizes the quadricopter 1.

With a quadricopter, the race no longer takes place on a track as it does for a car, but is in three dimensions. Under such circumstances, the race follows a circuit that is no longer represented by encrusted virtual markers as shown in FIG. 9, but that is defined for example by virtual circles 75 that are encrusted in the video image (cf. FIG. 13b) as delivered by the video camera 19, said circle floating in three dimensions. The player needs to fly the quadricopter 1 through the virtual circles 75.

As for the car, three views are possible: the video image delivered by the video camera 19 together with its virtual encrustations, the vertical view relying on a downloaded aerial image, and the perceptive view likewise based on a downloaded satellite or aerial image.

FIG. 13b gives an idea of a video image of encrusted virtual circles 75 of the kind that may arise during a game involving a quadricopter.

The positioning of the race circuit on the downloaded aerial image is determined in the same manner as for a car race. The circuit is positioned by hand by the player in such a manner as to be positioned suitably as a function of obstacles and buildings. Similarly, the user can scale the circuit, can turn it about the starting point, and can cause the starting point to slide around the track. The step of positioning the circuit 57 is shown in FIG. 13a.

In the same manner as for a car race, in a race involving a plurality of quadricopters, provision is made for a separate element to define the starting line, e.g. a pylon 77 carrying three flashing LEDs or reflector elements 71. The quadricopters or drones are aligned in a common frame of reference by means of the images from their cameras 19 and the significant points in the images as represented by the three flashing LEDs 71 of the pylon 77. Because all these geometrical parameters are known (camera position, focal length, etc.), the vehicle 1 is positioned without ambiguity in a common frame of reference. More precisely, the vehicle 1 is positioned in such a manner as to be resting on the ground with the pylon 77 in sight, and then it is verified on the screen of its console 3 that all three flashing LEDs 71 can be seen. The three flashing LEDs 71 represent significant points in recognizing the frame of reference. Because they are flashing at known frequencies, they can easily be identified by the software.

Once the position relative to the pylon 77 is known, the quadricopters 1 exchange information (each conveying to the other its position relative to the pylon 77) and in this way each quadricopter 1 deduces the position of its competitor.

The race can begin from the position of the quadricopter 1 from which the pylon 77 was detected by image processing. Nevertheless, it is naturally also possible to start the race from some other position, the inertial unit being capable of storing the movements of the quadricopters 1 from their initial position relative to the pylon 77 before the race begins.

Another possible game is a shooting game between two or more vehicles. For example, a shooting game may involve tanks each provided with a fixed video camera or with a video camera installed on a turret, or indeed it may involve quadricopters or it may involve quadricopters against tanks. Under such circumstances, there is no need to know the position of each vehicle relative to a circuit, but only to know the position of each vehicle relative to the other vehicle(s). A simpler procedure can be implemented. Each vehicle has LEDs flashing at a known frequency, with known colors, and/or in a geometrical configuration that is known in advance. By using the communications protocol, each vehicle exchanges with the others information concerning its type, the positions of its LEDs, the frequencies at which they are flashing, their colors, etc. Each vehicle is placed in such a manner that at the beginning of the game, the LEDs of the other vehicle are in the field of view of its video sensor 19. By performing a triangulation operation, it is possible to determine the position of each vehicle relative to the other(s).

The game can then begin. Each vehicle, by virtue of its inertial unit and its other measurement means, knows its own position and its movement. It transmits this information to the other vehicles.

On the video console, the image of an aiming site is encrusted, e.g. in the center of the video image transmitted by each vehicle. The player can then order projectiles to be shot at another vehicle.

At the time a shot is fired, given the position forwarded by the other vehicles and its own position direction and speed, the software of the shooting vehicle can estimate whether or not the shot will reach its target. The shot may simulate a projectile that reaches it target immediately, or else it may simulate the parabolic flight of a munition, or the path of a guided missile. The initial speed of the vehicle firing the shot, the speed of the projectile, the simulation of external parameters, e.g. atmospheric conditions, can all be simulated. In this way, shooting in the video game can be made more or less complex. The trajectory of missile munitions, tracer bullets, etc., can be displayed by being superimposed on the console.

The vehicles such as land vehicles or flying vehicles can estimate the positions of other vehicles in the game. This can be done by a shape recognition algorithm making use of the image from the camera 19. Otherwise, the vehicles may be provided with portions that enable them to be identified, e.g. LEDs. These portions enable other vehicles continuously to estimate their positions in addition to the information from their inertial units as transmitted by the radio means. This enables the game to be made more realistic. For example, during a battle game against one another, one of the players may hide behind a feature of the terrain, e.g. behind a tree. Even though the video game knows the position of the adversary because of the radio means, that position will not be shown on the video image and the shot will be invalid even if it was in the right direction.

When a vehicle is informed by its console that it has been hit, or of some other action in the game, e.g. simulating running out of fuel, a breakdown, or bad weather, a simulation sequence specific to the video game scenario may be undertaken. For example, with a quadricopter, it may start to shake, no longer fly in a straight line, or make an emergency landing. With a tank, it may simulate damage, run more slowly, or simulate the fact that its turret is jammed. Video transmission may also be modified, for example the images may be blurred, dark, or effects may be encrusted on the video image, such as broken cockpit glass.

The video game of the invention may combine:
player actions: driving the vehicles;
virtual elements: a race circuit or enemies displayed on the game console; and
simulations: instructions sent to the video toy to cause it to modify its behavior, e.g. an engine breakdown or a speed restriction on the vehicle, or greater difficulty in driving it.

These three levels of interaction make it possible to increase the realism between the video game on the console and a toy provided with sensors and a video camera.

1. A method of display adjustment (49) for a video game system (1, 3), the system comprising:
a remotely-controlled vehicle (1) with a sensor (31) for sensing the attitude of the vehicle (1); and
an electronic entity (3) including a display unit, the electronic entity (3) serving to control the vehicle (1) on a circuit (57) remotely;
the method being characterized in that it comprises the following steps:
using the sensor (31) to acquire the instantaneous attitude of the vehicle (1) dynamically;
dynamically estimating at least one inclination parameter of the circuit (57) from instantaneous attitude values delivered by the sensor (31); and
adjusting the display (49) of the electronic entity as a function of the estimated values for the inclination parameter(s) of the circuit (57).

2. A method according to claim 1, the display (49) of the electronic entity being constituted by a video image coming from a video sensor (19) arranged on the remotely-controlled vehicle (1), with virtual elements (51) being encrusted in the video image.

3. A method according to claim 2, adjustment of the display (49) including adjusting virtual markers (51) encrusted in the display of the electronic entity, the markers (51) serving to define the circuit (57).

4. A method according to claim 1, further including a training routine having the following steps:
storing estimated inclination parameter values corresponding to a lap around the circuit (57); and
using the stored values to refine the estimate of the inclination parameter(s) of the circuit (57).

5. A method according to claim 1, wherein the circuit inclination parameter(s) are estimated by a Kalman filter.

6. A method according to claim 1, wherein dynamically estimating comprises taking a first average of the instantaneous attitude over a long term and/or a second average of the instantaneous attitude over a short term to estimate respectively a first inclination parameter of the circuit (57), and/or a second inclination parameter of the circuit, wherein the first inclination parameter comprises a slope and the second inclination parameter comprises a roughness.

7. A method according to claim 1, wherein the remotely-controlled vehicle (1) is a land vehicle, in particular a race car.

8. A method according to claim 1, wherein the electronic entity (3) is a portable unit, in particular a portable game console or a mobile telephone.

9. A method according to claim 1, wherein communication between the electronic entity (3) and the remotely-controlled vehicle (1) takes place by short-range radio transmission (5), in particular by Bluetooth or WiFi protocol.
